(19) United States
(12) Patent Application Publication
(10) Pub. No.: US 2017/0364434 A1
(43) Pub. Date: Dec. 21, 2017

(54) SPLITTING AND MERGING MICROSERVICES

(71) Applicant: International Business Machines Corporation, Armonk, NY (US)

(72) Inventors: Sudheesh S. Kairali, Kozhikode (IN); Suresh Kodati, Bangalore (IN)

(21) Appl. No.: 15/182,718

(22) Filed: Jun. 15, 2016

(51) Int. Cl. G06F 11/36

(52) U.S. Cl. CPC G06F 11/3668

(57) ABSTRACT

A method, executed by a computer, includes receiving test data corresponding to a first microservice and a second microservice, determining, using the test data, whether the first microservice can be split, determining, using the test data, whether the first and second microservices can be merged, responsive to determining that the first microservice can be split, issuing a recommendation to split the first microservice, and responsive to determining that the first and second microservices can be merged, issuing a recommendation to merge the first microservice and the second microservice. A computer system and computer program product corresponding to the above method are also disclosed herein.

### BACKGROUND OF THE INVENTION

The present invention relates generally to microservices, and more specifically, to splitting a microservice into two or more microservices, or merging microservices into a single microservice.

In the field of computing, microservices are small, independent processes that communicate with each other to form complex applications. Microservices may be considered to be building blocks that enable a modular approach to applications. Microservices are seeing increasing use in cloud environments and can be provided as new services on a plug-and-play basis. One problem with microservices is that the functions of one microservice may overlap with another microservice. Another issue is that one microservice may perform multiple functions, when only one is desired for a particular application.

### SUMMARY

As disclosed herein, a method, executed by a computer, includes receiving test data corresponding to a first microservice and a second microservice, determining, using the test data, whether the first microservice can be split, determining, using the test data, whether the first and second microservices can be merged, responsive to determining that the first microservice can be split, issuing a recommendation to split the first microservice, and responsive to determining that the first and second microservices can be merged, issuing a recommendation to merge the first microservice and the second microservice. A computer system and computer program product corresponding to the above method are also disclosed herein.

### BRIEF DESCRIPTION OF THE DRAWINGS

FIG. 1 is a block diagram depicting an example of a microservice analysis system in accordance with embodiments of the present invention;

FIG. 2 is a flow chart depicting an example of a microservice splitting method in accordance with embodiments of the present invention;

FIG. 3 is a flow chart depicting an example of a microservice merging method in accordance with embodiments of the present invention; and

FIG. 4 is a block diagram depicting one example of a computing apparatus (i.e., computer) suitable for executing the methods disclosed herein.

### DETAILED DESCRIPTION

Embodiments of the present invention relate generally to microservices, and more specifically, to splitting a microservice into two or more microservices, or merging microservices into a single microservice. When a microservice is added to an environment, it may be selected for one of its many functionalities. If the microservice's other functionalities are not desired for the application at hand, it may be beneficial to split the undesired functionalities off of the microservice. This may decrease the amount of computing resources that the microservice utilizes and thus improve the efficiency of the overall environment. Similarly, if two or more microservices perform overlapping functionalities, and the redundancy is not intended, then the microservices may be merged into a single microservice that performs the desired functionality. Microservices may be split or merged based on the analysis of data generated during quality assurance and testing of the micro services.

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description and appended claims, or may be learned by the practice of the invention as set forth hereinafter. The present invention will now be described in detail with reference to the figures.

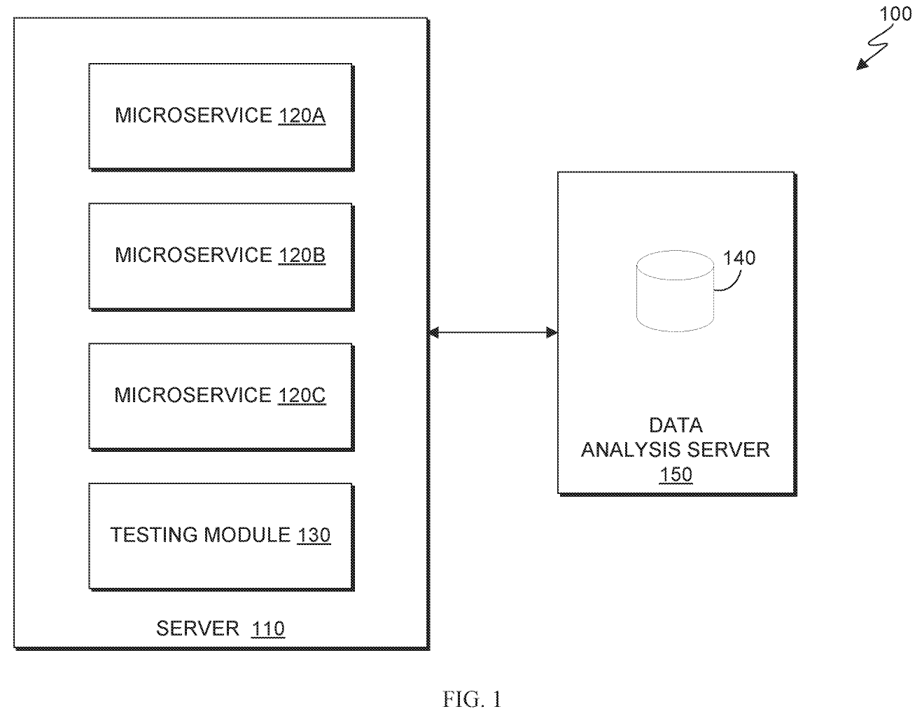

FIG. 1 is a block diagram depicting an example of a microservice analysis system 100 in accordance with embodiments of the present invention. As depicted, microservice analysis system 100 includes server 110 with microservices 120A-120C and testing module 130, test data storage 140, and data analysis server 150. Data analysis server 150 may receive data from server 100 that corresponds to the testing of microservices 120A-120C.

Server 110 may include any computing system capable of hosting the execution of one or more microservices. In the depicted embodiment, server 110 is hosting three microservices 120A-120C; however, server 110 may host more or fewer microservices. Server 110 may be responsible for deploying microservices, scaling microservices up or down, backing up microservices, and restoring backed-up microservices. Thus, server 110 may be responsible for managing microservices 120A-120C and allocating resources to microservices 120A-120C, such as processing resources, memory resources, and/or storage resources.

Microservices 120A-120C may include independently deployable services that have one or multiple functionalities. For example, each microservice may run in its own process and communicate with lightweight mechanisms such as an HTTP resource API. Whereas a monolith application may put all functionality into a single process and scale by replicating the monolith on multiple services, a microservice architecture may put elements of functionality into separate microservices, and scale by distributing these microservices across servers, replicating as needed.

Testing module 130 may test microservices 120A-120C during their execution. In some embodiments, testing module 130 performs quality assurance testing on microservices 120A-120C. As testing module 130 tests and observes the execution of microservices 120A-120C, testing module 130 may generate testing data. The testing data may be stored locally to server 110 and/or sent to data analysis server 150 to be stored in test data storage 140. Test data storage 140 may include any form of data storage, such as a hard drive, flash storage, memory, magnetic tape storage, or the like.

Data analysis server 150 may analyze the testing data and issue recommendations as to whether microservices can be split or merged. Data analysis server 150 may reside on server 110 as a module, on another server, or as a stand-alone server. Data analysis server 150 may receive testing data from server 110 or testing module 130, and store the testing data in test data storage 140 for analysis. In analyzing the testing data, data analysis server 150 may determine that a microservice can be split, or that two or more microservices can be merged. Analyzing microservices to determine whether they may be split or merged may occur along the lines of a microservice's independent functionalities/functional responsibilities. For example, data analysis server 150 may determine that a microservice performs functions A and B, and recommend splitting the microservice into a microservice for function A, and another microservice for function B. Similarly, data analysis server 150 may determine that microservices A and B perform the same function X, and merge microservice B's functionality into microservice A.

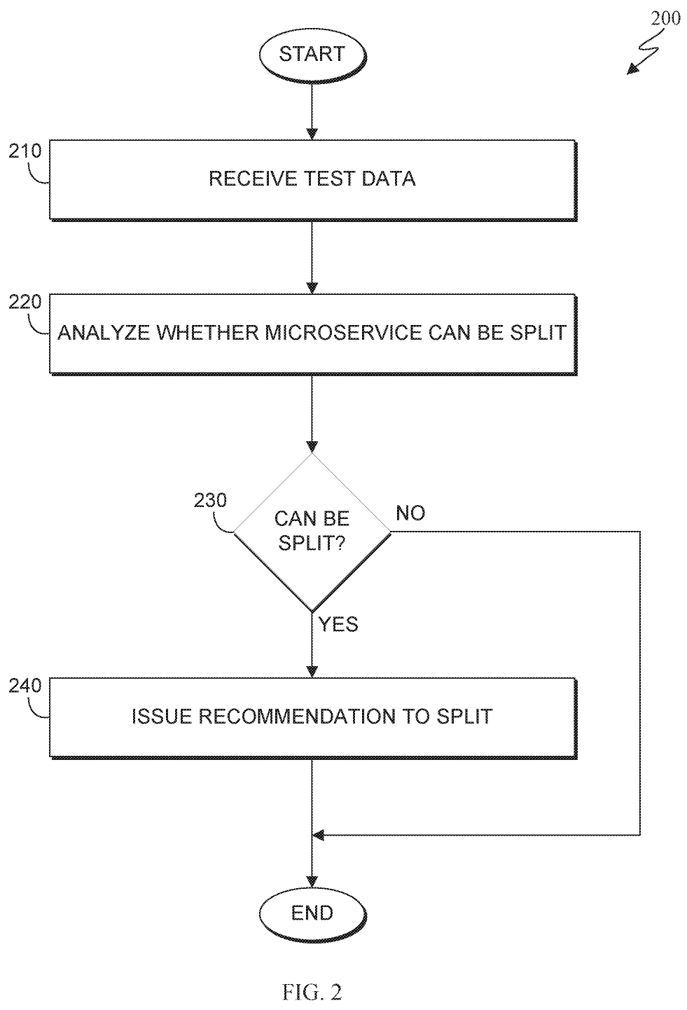

FIG. 2 is a flow chart depicting an example of a microservice splitting method 200 in accordance with embodiments of the present invention. As depicted, microservice splitting method 200 includes receiving (210) test data, analyzing (220) whether the microservice can be split, determining (230) whether to split the microservice, and issuing (240) a recommendation to split the microservice. The microservice splitting method 200 may analyze quality assurance and/or testing data for a single microservice to determine whether it can be split into two or more microservices.

Receiving (210) test data may include receiving test data generated from the testing of a microservice. For example, test data corresponding to microservice 120B may be generated by testing module 130, then received by test data storage 140 to be accessed and analyzed by data analysis server 150. Test data may be received live during testing of a microservice or may be received as a whole after testing.

Analyzing (220) whether the microservice can be split may include analyzing the test data to look for multiple functionalities of the microservice. For example, if a microservice performs two or more independent functionalities, then each functionality may be split into a separate microservice. Such functionalities may include, for example, handling HTTP requests, executing logic, retrieving or updating data in a database, or other tasks. Upon determining that a microservice has two or more independent functionalities, the splitting determination operation 230 proceeds to the recommendation issuance operation 240; otherwise microservice splitting method 200 terminates.

Issuing (240) a recommendation to split the microservice may include issuing a notification that microservice splitting method 200 has determined that a microservice can be split. In some embodiments, the recommendation may be issued or displayed to a user. In response to issuing the recommendation, a user may split the microservice into two or more microservices according to its independent functionalities in a subsequent development cycle. For example, if a microservice is responsible for updating a database and handling HTTP requests, the microservice may be split into two microservices: one microservice may update a database, and the other may handle HTTP requests.

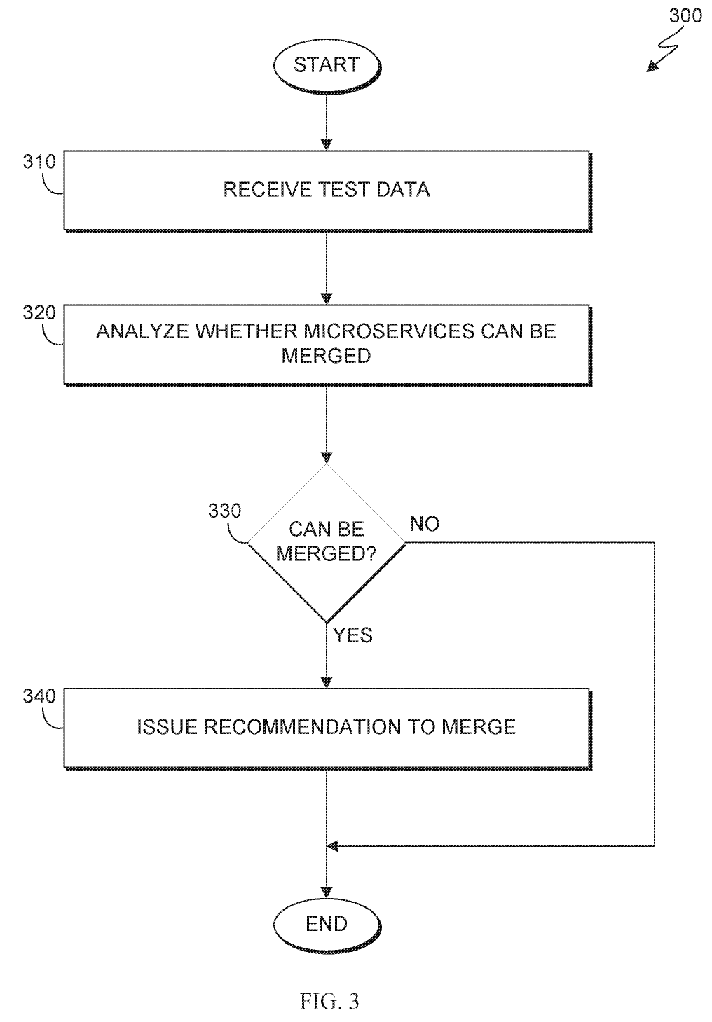

FIG. 3 is a flow chart depicting an example of a microservice merging method 300 in accordance with embodiments of the present invention. As depicted, microservice merging method 300 includes receiving (310) test data, analyzing (320) whether the microservice can be split, determining (330) whether to split the microservice, and issuing (340) a recommendation to split. The microservice merging method 200 may analyze quality assurance and/or testing data for two or more microservices to determine whether they can be merged into a single microservice.

Receiving (310) test data may include receiving test data generated from the testing of microservices. For example, test data corresponding to microservices 120B and 120C may be generated by testing module 130 during the course of testing, then received by test data storage 140 to be accessed and analyzed by data analysis server 150. Test data may be received live during testing of microservices or may be received as a whole after testing.

Analyzing (320) whether the microservices can be merged may include analyzing the test data to look for microservices that share one or more functionalities. For example, if microservice 120A, 120B, and 120C all perform the same function, then all three may be merged together into one microservice. Alternatively, if microservices 120A-120C all share one functionality, but microservices 120B and 120C each perform additional tasks, then the shared functionality may be split from microservice 120B and 120C to be merged with 120A, leaving microservices 120B and 120C free to perform their other additional functionalities.

There may be multiple reasons to recommend splitting or merger of two or more microservices. If two microservices share functionality, they may be merged insofar as that functionality goes. In some embodiments, when a first microservice depends partially on a second microservice for scaling the first microservice, that portion relating to scaling can be removed from the second microservice and added to the first microservice. Similarly, if a first microservice depends partially on a second microservice for deployment, that portion relating to deploying the first microservice may be split from the second microservice and merged with the first microservice. If a first microservice depends, at least partially, on a second microservice to back up or restore, the functionality of the second microservice relating to back up and restore may be split from the second microservice and merged with the first microservice. In some embodiments, functionality that is merged into a target microservice may not be split from the source microservice, thus increasing redundancy of the functionality being merged (as now both the target and source microservice may perform the functionality).

Upon determining that two or more microservices have shared functionality, the splitting determination operation 330 proceeds to the recommendation issuance operation 340; otherwise microservice merging method 300 terminates.

Issuing (340) a recommendation to merge may include issuing a notification that microservice merging method 300 has determined that two or more microservices can be merged. In some embodiments, the recommendation may be issued or displayed to a user. In response to issuing the recommendation, a user may merge the two or more microservices into one microservice according to its functionalities in a subsequent development cycle. For example, if both microservices share the functionality of handling HTTP requests, then that functionality may be removed from one of the microservices and preserved or merged into the other microservice.

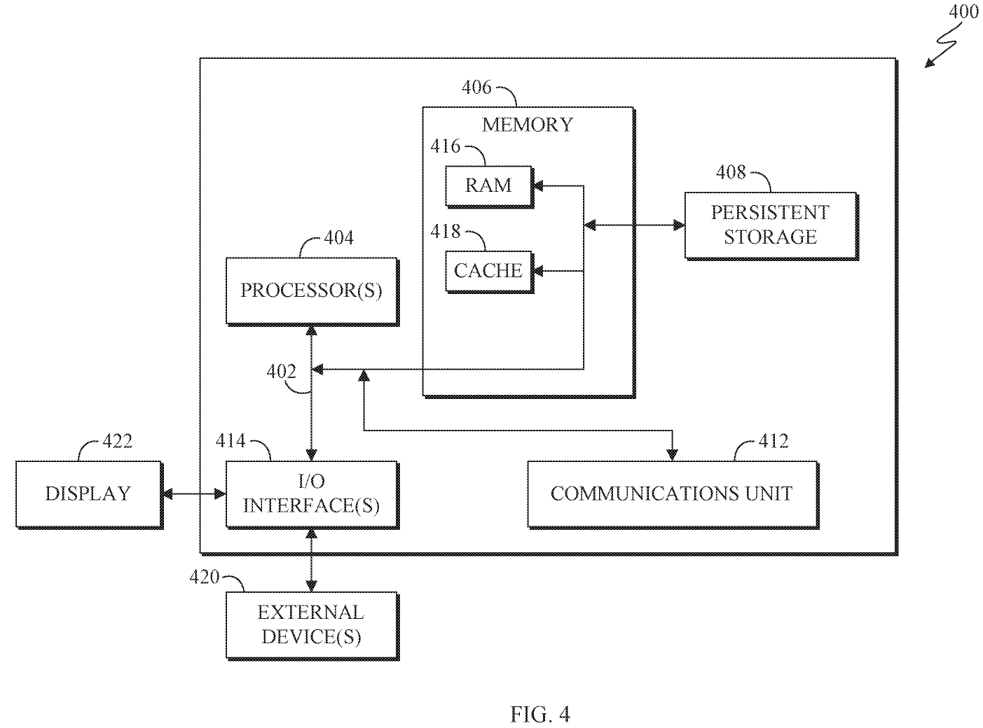

FIG. 4 is a block diagram depicting components of a computer 400 suitable for executing the methods disclosed herein. It should be appreciated that FIG. 4 provides only an illustration of one embodiment and does not imply any limitations with regard to the environments in which different embodiments may be implemented. Many modifications to the depicted environment may be made.

As depicted, the computer 400 includes communications fabric 402, which provides communications between computer processor(s) 404, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In the depicted embodiment, memory 406 includes random access memory (RAM) 416 and cache memory 418. In general, memory 406 can include any suitable volatile or non-volatile computer readable storage media.

One or more programs may be stored in persistent storage 408 for execution by one or more of the respective computer processors 404 via one or more memories of memory 406. The persistent storage 408 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links.

I/O interface(s) 414 allows for input and output of data with other devices that may be connected to computer 400. For example, I/O interface 414 may provide a connection to external devices 420 such as a keyboard, keypad, a touch screen, and/or some other suitable input device. External devices 420 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 408 via I/O interface(s) 414. I/O interface(s) 414 may also connect to a display 422. Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The embodiments disclosed herein include a system, a method, and/or a computer program product. The computer program product may include a computer readable storage medium (or media) having computer readable program instructions thereon for causing a processor to carry out the methods disclosed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, executed by a computer, the method comprising:
receiving test data corresponding to a first microservice and a second microservice;
determining, using the test data, whether the first microservice can be split;
determining, using the test data, whether the first and second microservices can be merged;
responsive to determining that the first microservice can be split, issuing a recommendation to split the first microservice; and
responsive to determining that the first and second microservices can be merged, issuing a recommendation to merge the first microservice and the second microservice.

2. The method of claim 1, wherein determining whether the first microservice can be split comprises determining that the first microservice has multiple independent functionalities; and
wherein issuing a recommendation to split comprises issuing a recommendation to split the first microservice into a plurality of microservices, wherein each microservice of the plurality of microservices corresponds to one of the multiple independent functional responsibilities.

3. The method of claim 1, wherein determining whether the first and second microservices can be merged comprises determining that the first microservice and the second microservice share a functionality; and
wherein issuing a recommendation to merge comprises issuing a recommendation to remove the functionality from the second microservice and to merge the functionality into the first microservice.

4. The method of claim 1, wherein determining whether the first and second microservices can be merged comprises determining that the first microservice depends partially on the second microservice during deployment of the first microservice.

5. The method of claim 1, wherein determining whether the first and second microservices can be merged comprises determining that the first microservice depends partially on the second microservice when scaling the first microservice.

6. The method of claim 1, wherein determining whether the first and second microservices can be merged comprises determining that the first microservice depends partially on the second microservice during a backup operation of the first microservice.

7. The method of claim 1, wherein determining whether the first and second microservices can be merged comprises determining that the first microservice depends partially on the second microservice during a restore operation of the first microservice.

8. A computer system comprising:
one or more computer processors;
one or more computer readable storage media;
program instructions stored therein for execution by at least one of the one or more computer processors, the program instructions comprising instructions for:
receiving test data corresponding to a first microservice and a second microservice;
determining, using the test data, whether the first microservice can be split;
determining, using the test data, whether the first and second microservices can be merged;
responsive to determining that the first microservice can be split, issuing a recommendation to split the first microservice; and
responsive to determining that the first and second microservices can be merged, issuing a recommendation to merge the first microservice and the second microservice.

9. The computer system of claim 8, wherein determining whether the first microservice can be split comprises determining that the first microservice has multiple independent functionalities; and
wherein issuing a recommendation to split comprises issuing a recommendation to split the first microservice into a plurality of microservices, wherein each microservice of the plurality of microservices corresponds to one of the multiple independent functional responsibilities.

10. The computer system of claim 8, wherein determining whether the first and second microservices can be merged comprises determining that the first microservice and the second microservice share a functionality; and
wherein issuing a recommendation to merge comprises issuing a recommendation to remove the functionality from the second microservice and to merge the functionality into the first microservice.

11. The computer system of claim 8, wherein determining whether the first and second microservices can be merged comprises determining that the first microservice depends partially on the second microservice during deployment of the first microservice.

12. The computer system of claim 8, wherein determining whether the first and second microservices can be merged comprises determining that the first microservice depends partially on the second microservice when scaling the first microservice.

13. The computer system of claim 8, wherein determining whether the first and second microservices can be merged comprises determining that the first microservice depends partially on the second microservice during a backup operation of the first microservice.

14. The computer system of claim 8, wherein determining whether the first and second microservices can be merged comprises determining that the first microservice depends partially on the second microservice during a restore operation of the first microservice.

15. A computer program product comprising:
a computer readable storage medium and program instructions stored on the computer readable storage medium, the program instructions comprising instructions for:
receiving test data corresponding to a first microservice and a second microservice;
determining, using the test data, whether the first microservice can be split;
determining, using the test data, whether the first and second microservices can be merged;
responsive to determining that the first microservice can be split, issuing a recommendation to split the first microservice; and
responsive to determining that the first and second microservices can be merged, issuing a recommendation to merge the first microservice and the second microservice.

16. The computer program product of claim 15, wherein determining whether the first microservice can be split comprises determining that the first microservice has multiple independent functionalities; and
wherein issuing a recommendation to split comprises issuing a recommendation to split the first microservice into a plurality of microservices, wherein each microservice of the plurality of microservices corresponds to one of the multiple independent functional responsibilities.

17. The computer program product of claim 15, wherein determining whether the first and second microservices can be merged comprises determining that the first microservice and the second microservice share a functionality; and
wherein issuing a recommendation to merge comprises issuing a recommendation to remove the functionality from the second microservice and to merge the functionality into the first microservice.

18. The computer program product of claim 15, wherein determining whether the first and second microservices can be merged comprises determining that the first microservice depends partially on the second microservice during deployment of the first microservice.

19. The computer program product of claim 15, wherein determining whether the first and second microservices can be merged comprises determining that the first microservice depends partially on the second microservice when scaling the first microservice.

20. The computer program product of claim 15, wherein determining whether the first and second microservices can be merged comprises determining that the first microservice depends partially on the second microservice during a backup operation of the first microservice.
